(19) United States
(12) Patent Application Publication
(10) Pub. No.: US 2015/0017399 A1
(43) Pub. Date: Jan. 15, 2015

(54) METHOD OF PRODUCING A FUNCTIONALIZED SURFACE AND SURFACES MADE THEREBY

(71) Applicants: Jas Pal Singh BADYAL, Wolsingham (GB); Vincent ROUCOULES, Durham (GB); Wayne Christopher Edward SCHOFIELD, Durham (GB)

(72) Inventors: Jas Pal Singh BADYAL, Wolsingham (GB); Vincent ROUCOULES, Durham (GB); Wayne Christopher Edward SCHOFIELD, Durham (GB)

(21) Appl. No.: 14/495,581

(22) Filed: Sep. 24, 2014

Related U.S. Application Data
(63) Continuation of application No. 14/232,761, now abandoned.

(30) Foreign Application Priority Data
Jul. 14, 2011 (GB) 1112077.1

(51) Int. Cl. B05D 5/00; B05D 3/06; B05D 3/14; B05D 1/00

(52) U.S. Cl. CPC B05D 5/00; B05D 1/60; B05D 1/62; B05D 3/067; B05D 3/068; B05D 3/147
USPC 428/195.1; 204/192.15; 427/256; 427/569; 427/488; 427/255.6; 427/582; 427/504; 427/585; 427/532; 427/535; 427/552; 427/558

(57) ABSTRACT

A method of photopatterning rewritable reactive groups onto surfaces using typically a plasmachemical deposition of functionalized materials, followed by molecular printing of inks. Subsequent treatment of the reactive groups allows for surface rewriting and also the method allows for the creation of either positive or negative image multifunctional rewritable patterned surfaces.

### FIELD OF THE INVENTION

The current invention relates to a method of producing a functionalized surface and in particular but not exclusively to patterned functionalized surface that can be rewritten. Furthermore the invention relates to functionalized surfaces made by the method described.

### BACKGROUND OF THE INVENTION

Patterned functional surfaces are widely used for a whole host of applications including integrated optics, engineering templates, sensor arrays, nano-electronic devices and cellular interactions. An important attribute which is often sought is directed rewritability, which although well established for bulk materials such as holographic image storage, electronic memory devices, thermal recording materials, photo-detectors, inks, and optical data storage it remains a challenge for surface molecular printing.

For instance, dye attachment to surfaces is of relevance to molecular lattice devices, organic photoreceptors, clinical immunoassays, specific cell marking (dye-protein interactions), and genetics (dye-DNA interactions). However, currently there only exist non-rewritable methods for dye patterning onto solid surfaces; for example, soft-lithography, UV irradiation, and ink-jet printing. In each case, the dye molecule is reacted with functional groups already present at the surface (which have normally been prepared by a substrate-dependent multistep procedure).

The present invention seeks to overcome the problems of the prior art by providing patterned functionalized surfaces that can be deposited easily onto surfaces, and which can be re-written.

### SUMMARY OF THE INVENTION

According to a first embodiment of the invention there is provided a method of producing a patterned functionalized surface, the method involving:
(i) contacting a surface with a plasma polymer having reactive groups so the groups are deposited on the surface to produce a functionalized polymer layer on said surface; and
(ii) contacting the functionalized polymer layer with a functional molecule that reacts with the functionalized polymer layer to produce a patterned surface having one or more areas of reactive surface functionality.

It is envisaged that the substrate for the surface can be any solid material. An example of the substrate material is any solid, particulate, permeable and/or porous substrate or finished article, consisting of any materials (or combination of materials) as are known in the art. Examples of materials include, but are not limited to, woven or non-woven fibres, natural fibres, synthetic fibres, metal, glass, ceramics, semiconductors, cellulosic materials, paper, wood, or polymers such as polytetrafluoroethylene, polyethylene or polystyrene. In particular the solid material may by silicon.

It is envisaged that the polymer is formed by plasma polymerization, thermal chemical vapour deposition, initiated chemical vapour deposition (iCVD), photodeposition, ion-assisted deposition, electron beam polymerization, gamma-ray polymerization, target sputtering, graft polymerization, or solution phase polymerization. Preferably the polymer is formed by plasma deposition and in particular by pulsed plasma deposition,

It is envisaged that the reactive group is an anhydride and in particular the anhydride is plasma deposited using maleic anhydride precursor. Individual anhydrides precursors may be used or combinations of compounds which have groups that can be functionalized.

It is preferred that the functional molecule dye, such as a nucleophile containing ink and this ink is typically cresyl violet perchlorate. Individual or combinations of dyes/inks may be used.

It is preferred that the functionalized polymer layer is polymerized prior to contacting with the dye as in step (ii).

It is envisaged that the patterned surface is produced by irradiating the functionalized polymer layer in discrete areas prior to contacting said layer with one or more dyes.

In an alternative situation the patterned surface is produced by irradiating the functionalized polymer layer after contacting said layer with the dye.

It is envisaged that irradiation is undertaken using a beam of plasma, photons, electrons, ions, radicals, atomic species, or molecular species. Preferably the radiation is UV irradiation and typically the pattern is produced by irradiating through a mask. The pattern may be produced using a focused irradiation source.

In a preferred arrangement the patterned functionalized surface is erasable to allow rewriting of the patterned functionalized surface.

It envisaged that the surface density of the groups or dye on the surface is controlled by varying the plasma cycle, typically the plasma duty cycle.

Typically, the patterning of the surface is negative or positive image UV patterning.

According to a further embodiment of the invention there is provided a method of producing a functionalized polymer layer to be patterned according to any preceding claim, the method involving contacting a surface with a plasma polymer having reactive groups so the groups are deposited on the surface to produce a functionalized polymer layer on said surface.

According to another embodiment of the invention there is provided a functionalized patterned surface produced by a method according to any one of the preceding claims.

In yet a further embodiment there is provided a functionalized polymer layer produced by a method according to claim 22.

It is envisaged that a functionalized patterned surface or functionalized polymer layer according to the embodiments of the invention are used in molecular lattice devices, organic photoreceptors, clinical immunoassays, specific cell marking (dye-protein interactions), and genetics (dye-DNA interactions).

Furthermore, the functionalized patterned surface or functionalized polymer layer can be included in kits including molecular lattice devices, organic photoreceptors, clinical immunoassays, specific cell marking (dye-protein interactions), and genetics (dye-DNA interactions).

The invention has particular advantages in that it allows for nucleophile containing ink molecules to be patterned onto pulsed plasma deposited maleic anhydride nano-film surfaces. Both positive and negative rewritable images can be created by utilising UV lithography in combination with chemical regeneration of surface anhydride groups as a typical method of using the invention.

### BRIEF DESCRIPTION OF THE FIGURES

An embodiment of the invention will be described with reference to and as illustrated in the accompanying figures by way of example only, in which:

FIG. 1 shows: Infrared spectroscopy: (a) reflection-absorption spectra of deposited maleic anhydride pulsed plasma polymer; (b) absorbance spectra of cresyl violet perchlorate dye; and (c) reflection-absorption spectra of plasma polymer functionalised with cresyl violet perchlorate dye;

FIG. 2 shows: negative image UV patterning of surface immobilised cresyl violet dye;

FIG. 3 shows: positive image UV patterning of surface immobilised cresyl violet dye molecules using anhydride group regeneration step;

FIG. 4 shows: optical and fluorescence microscopy images of UV patterned surfaces of cresyl violet perchlorate dye molecules attached to maleic anhydride pulsed plasma polymer: (a) negative patterning and (b) positive patterning;

FIG. 5 shows: infrared reflection-absorption spectra of: (a) deposited maleic anhydride pulsed plasma polymer; (b) plasma polymer functionalised with 4-ethylaniline; (c) plasma polymer functionalised with 4-ethylaniline and heated at 120° C.; (d) UV irradiation and hydrolysis of (c); (e) regenerated anhydride group; and (f) functionalization of (e) with cresyl violet perchlorate dye.

FIG. 6 shows: a schematic method showing the re-writable property of the maleic anhydride pulsed plasma polymer film surfaces.

FIG. 7 shows: (a) bifunctional patterned surface via UV exposure of surface immobilised Dye 1 (cresyl violet perchlorate) molecules followed by regeneration of anhydride groups and immobilisation of Dye 2 (HiLyte Fluor 488 amine) molecules. (b) Corresponding fluorescence microscopy image showing cresyl violet perchlorate (red) and HiLyte Fluor 488 (blue) dye molecules attached to maleic anhydride pulsed plasma polymer

### DETAILED DESCRIPTION OF EMBODIMENTS OF THE INVENTION

In general the invention involves film formation where there is generation of active sites (predominantly radicals) at the substrate surface and within the electrical discharge during the short plasma duty cycle on-period (microseconds). This process is followed by conventional polymerization reaction pathways proceeding during each prolonged extinction off-period (milliseconds) to yield well-defined poly (maleic anhydride) nano-films. The reactive surface anhydride functionalities can then be employed to tether functional molecules (for example dyes such as cresyl violet perchlorate. Furthermore, the rewritable patterning of these surfaces is demonstrated by subsequent UV lithography to facilitate the removal of immobilised molecules and regeneration of reactive anhydride groups in readiness for the next write step. This methodology provides scope for the fabrication of either positive or negative image patterned functional surfaces. Some inherent advantages of this approach include the fact that the plasmachemical surface functionalization step is substrate independent (due to the activating nature of the electrical discharge) and also the surface density of tethered molecular species can be finely tuned by varying the pulsed plasma duty cycle.

Deposition of Anhydride Functionalized Nano-layers

Briquettes of maleic anhydride (Aldrich, +99%) were ground into a fine powder and loaded into a glass monomer tube prior to attachment to an electrodeless cylindrical glass plasma reactor (4.5 cm diameter, 460 cm³ volume, base pressure of 5×10^{-'} mbar, with a leak rate lower than 1.0×10⁻¹⁰ kgs⁻¹) enclosed in a Faraday cage. This was fitted with an externally wound copper coil (4 mm diameter, 9 turns, spanning 8-15 cm from the gas inlet), a thermocouple pressure gauge, and a 30 L min⁻¹ twostage rotary pump connected to a liquid nitrogen cold trap. All joints were greasefree. An L-C circuit matched the output impedance of the RF power generator (13.56 MHz) to that of the partially ionised gas load. Pulsed plasma deposition entailed triggering the RF power supply from a signal generator. The pulse width and amplitude were monitored with an oscilloscope. Prior to each experiment, the reactor was cleaned with detergent and then a 30 min high-power (50 W) air plasma treatment. Next, the chamber was vented to air and a piece of silicon substrate (MEMC Electronic Materials, +99.9%) was placed into the centre, followed by evacuation back down to base pressure. At this stage, maleic anhydride vapour was introduced into the reactor at a constant pressure of 0.2 mbar, followed by plasma ignition. The optimum deposition conditions corresponded to power (Pcw)=5 W, pulse on-time (ton)=20 μs, off-time (toff)=1200 μs, and total deposition time=30 min. Upon plasma extinction, the RF supply was switched off, and the monomer feed is allowed to continue flowing through the system for a further 5 min prior to evacuating to base pressure.

The deposited maleic anhydride pulsed plasma polymer film thickness was estimated by reflectometry to be 92±5 nm. XPS analysis indicated five types of carbon functionality in the C(1s) envelope: hydrocarbon (CHₓ˜285.0 eV), carbon singly bonded to an anhydride group (C—C(O)—O—˜285.7 eV), carbon singly bonded to oxygen (—C—˜286.6 eV), carbon doubly bonded to oxygen (O—C—O/—C═O˜287.9 eV), and anhydride groups (O═C—O—C═O˜289.4 eV), Complete coverage of the underlying silicon substrate was confirmed by the absence of any Si(2p) signal showing through.

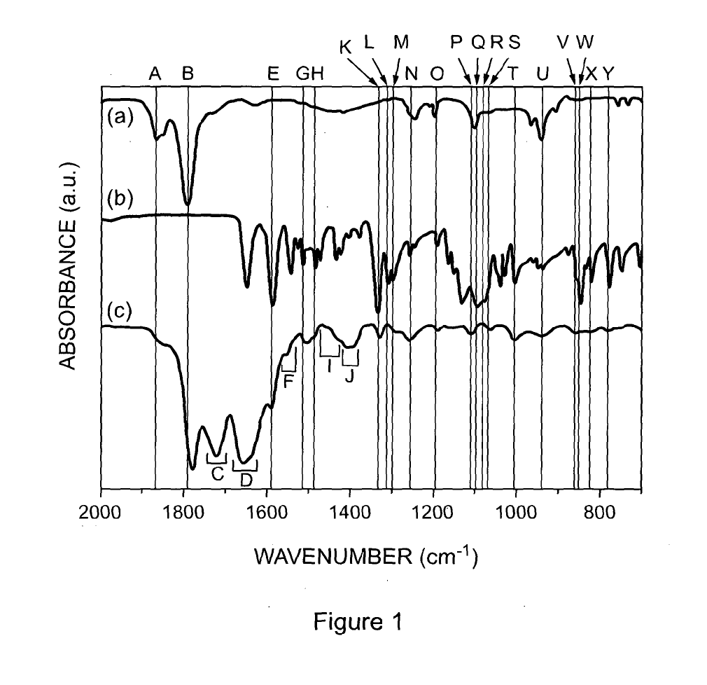

Infrared analysis confirmed structural retention of the anhydride groups in the pulsed plasma deposited layers and this is shown in FIG. 1. The following characteristic cyclicanhydride absorbances were identified: asymmetric and symmetric C═O stretching (1860 cm⁻¹ (A) and 1796 cm⁻¹ (B)), cyclic conjugated anhydride group stretching (1241 cm⁻¹ (N)) and 1196 cm⁻¹ (O)), C—O—C stretching vibrations (1097 cm⁻¹ (P) and 1062 cm⁻¹ (S)), and cyclic unconjugated anhydride group stretching (964 cm⁻¹, 938 cm⁻¹ and 906 cm⁻¹ (U)).

Inclusion of Dyes

Attachment of dyes to the surface of the functionalized layer entailed immersion of a piece of pulsed maleic anhydride plasma polymer coated substrate into a 1×10⁻⁵ M solution of cresyl violet perchlorate (+99.9%, Aldrich) dissolved in anhydrous N,N-dimethylformamide (+99.9%, Aldrich) for 1 hour (this solvent avoids the hydrolysis of anhydride groups40). Afterwards, the surface was rinsed with N,N-dimethylformamide and dried under a stream of nitrogen. For bifunctional patterning, HiLyte Fluor 488 amine dye (Cambridge Bioscence) was used in a similar fashion.

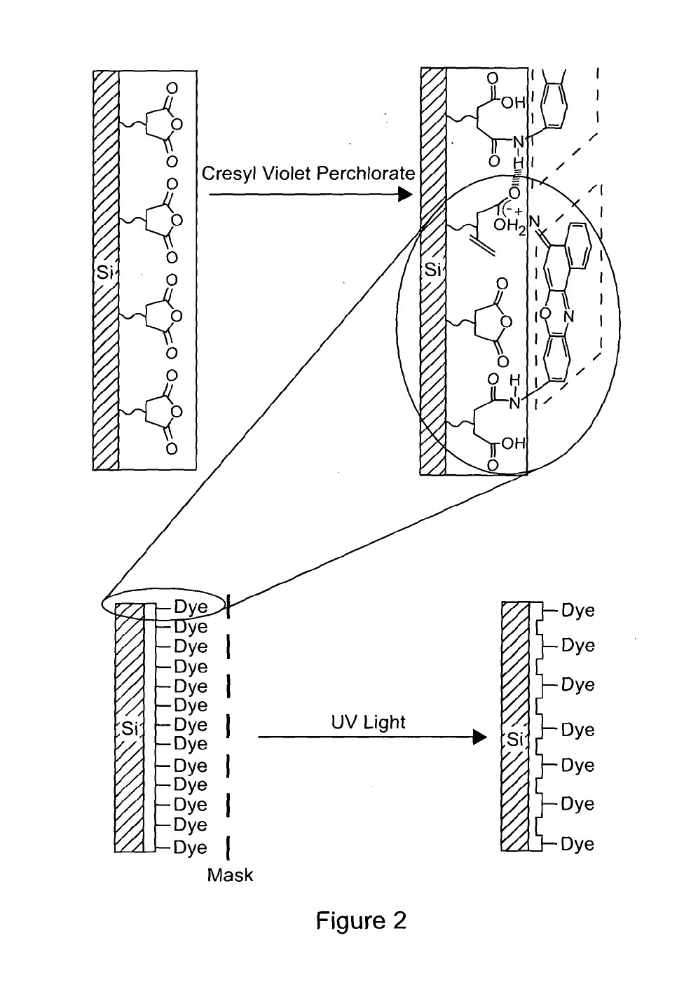

The cresyl violet perchlorate dye molecule (which contains amine groups) displays two intense bands in the infrared absorption spectrum 1591 cm⁻¹ (NH bending (E)) and 1335 cm⁻¹ (C—N stretching/C—N—H bending of the amine groups (K)) as shown in FIG. 2. A number of other characteristic absorbances were also identified for this molecule: 1649 cm⁻¹, 1544 cm⁻¹, 1514 cm⁻¹, 1485 cm⁻¹, 1435 cm⁻¹, 1308 cm⁻¹, 1298 cm⁻¹, 1129 cm⁻¹, 1093 cm⁻¹, 1076 cm⁻¹, 1004 cm⁻¹, 856 cm⁻¹, 845 cm⁻¹, 818 cm⁻¹, and 776 cm⁻¹.

Immersion of the maleic anhydride pulsed plasma polymer layer into a solution of cresyl violet perchlorate dissolved in N,N-dimethylformamide gave rise to dye attachment at the surface via amide linkages (aminolysis reaction) and electrostatic acid-base interactions and negative patterning is shown in FIG. 2. Infrared spectroscopy confirmed the presence of: amide groups (amide I at 1656 cm⁻¹ (D) and amide II at 1553 cm⁻¹ (F)), carboxylic acid stretching (1721 cm⁻¹ (C)), and C—NH monosubstituted amide stretching (1470-1420 cm⁻¹ (I)). The accompanying acid-base interaction arising from the other amine group in the dye molecule manifests in the symmetric COO— stretching band (1405 cm⁻¹ (J)). An absence of the NH₂⁺ bending mode (1520 cm-1) and presence of only the NH₂⁺, bending mode (1591 cm-1 (E)) is consistent with aminolysis occurring at only one end of the dye molecule. In addition, the following fingerprint associated with the cresyl violet dye molecule were observed: 1514 cm⁻¹ (G), 1485 cm⁻¹ (H), 1335 cm⁻³ (K), 1308 cm⁻¹ (L), 1298 cm⁻¹ (M), 1093 cm⁻¹ (Q) 1076 cm⁻¹ (R), 1004 cm⁻¹ (T), 856 cm⁻¹ (V), 845 cm⁻¹ (W), 818 cm⁻¹ (X) and 776 cm⁻¹ (Y).

The continued presence of background maleic anhydride pulsed plasma polymer infrared bands (1860 cm⁻¹ (A), 1796 cm⁻¹ (B), 1241 cm⁻¹ (N), 1196 cm⁻¹ (O), 1097 cm⁻¹ (P), 1062 cm⁻¹ (S) and 938 cm⁻¹ (U)) confirmed that reaction had only taken place at the solid-solution interface.

A corresponding change in the elemental XPS composition was found at the plasma polymer surface following exposure to cresyl violet perchlorate solution. The absence of any chlorine signal originating from the parent cresyl violet molecule is consistent with the model depicted in FIG. 2. An accompanying change in the C(1s) envelope was also evident comprising hydrocarbon (CH, ˜285.0 eV), carbon singly bonded to an amide/carboxylic acid groups (CH₂C(O)NHR/CH₂C—(O)OH˜285.6 eV), amine groups (C—NH₂˜286.0 eV), carbon singly bonded to oxygen (C—O˜286.4 eV) amide groups (RNH—C═O˜287.9 eV), and anhydride/carboxylic acid/carbonyl groups (O═C—O—C═O/C(O)OH/C(O)O—˜289.4 eV). Whilst two types of nitrogen functionality were identified in the N(1s) spectrum: amide linkage groups/nitrogen atom belonging to the central dye molecule ring (RNH—C═O/C—N═C˜399.8 eV), and the counter-ion (C═NH₂⁺˜400.8 eV), in accordance with the expected 2:1 stoichiometric ratio.

Surface Patterning

Surface patterning entailed UV irradiation (Hg—Xe lamp, Model 6136, Oriel Corporation) through a copper mask (5 μm grid width, with 20 μm×20 μm open squares, Agar Scientific Ltd) for 1 hour in ambient air. For the bifunctional dye patterns, nickel masks were used (2000 mesh: 7.5 μm open squares, 5 μm bar width, Agar Scientific Ltd). In the case of negative image generation, UV photopatterning of the maleic anhydride plasma polymer surface worked for both prior to or following dye molecule immobilisation, as shown in FIG. 2.

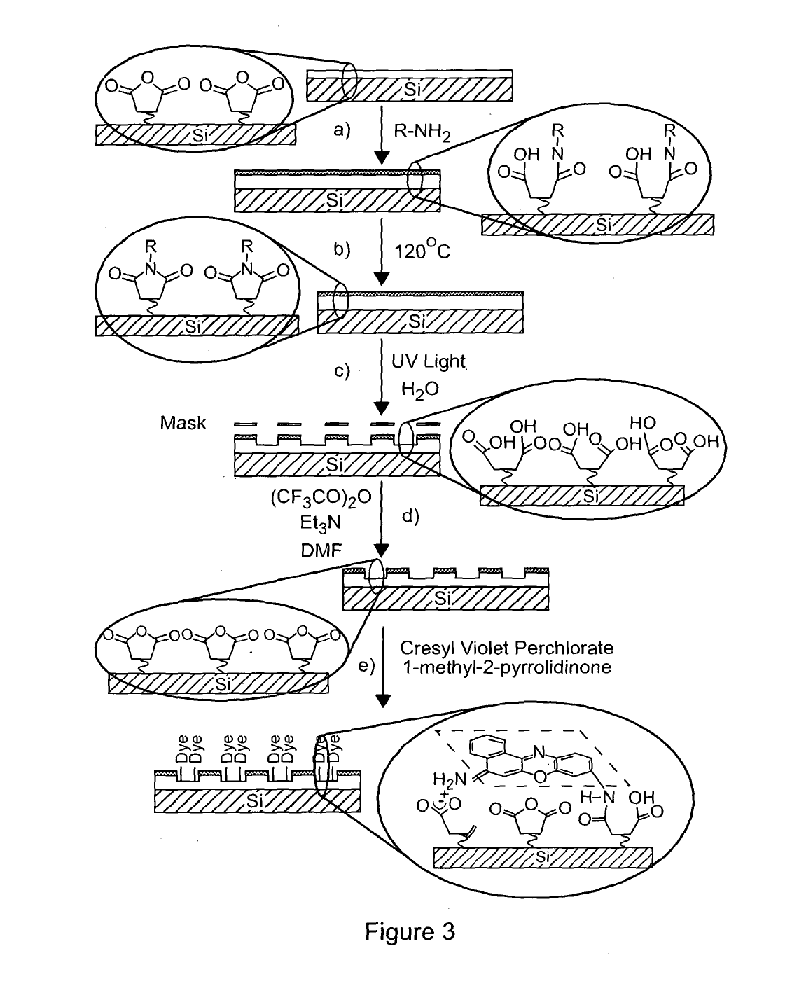

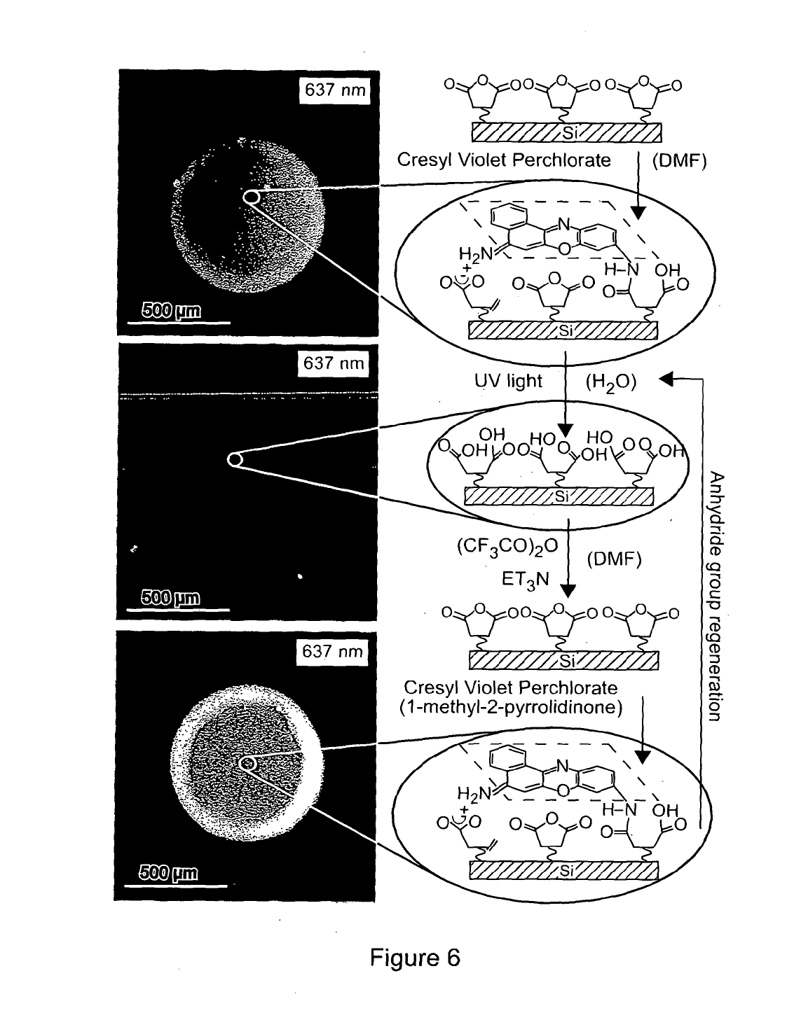

Whilst in the case of positive image formation FIG. 3, the maleic anhydride pulsed plasma polymer film was first capped by aminolysis with 4-ethylaniline (Aldrich, 98%) vapour at 1 mbar pressure in a sealed glass chamber at ˜20° C. for 45 min. The whole apparatus was then pumped back down to base pressure, and the functionalized substrate placed into an oven at 120° C. for 2 hours to facilitate imidization. The surface was then UV photopatterned, rinsed in ultra purified water (30 min) and dried under a stream of nitrogen. Re-activation of the UV-exposed areas consisted of dipping the substrate into a solution of 0.1 M trifluoroacetic anhydride (Aldrich, +99%) and 0.2 M triethylamine (Aldrich, 99.5%) dissolved in anhydrous N,Ndimethylformamide for 20min, and then rinsing in dichloromethane followed by drying under nitrogen. The regenerated surface anhydride groups were then ready for further chemical reactions and a schematic of this is shown in FIG. 6.

Film thickness measurements were carried out using a spectrophotometer (nkd-6000, Aquila Instruments Ltd.). The obtained transmittance-reflectance curves (350-1000 nm wavelength range) were fitted to the Cauchy model for dielectric materials using a modified Levenberg-Marquardt method.

XPS analysis was undertaken using a VG ESCALAB MKII electron spectrometer equipped with an unmonochromated Mg Kα X-ray source (1253.6 eV) and a concentric hemispherical analyser. Photo emitted electrons were collected at a take-off angle of 30° from the substrate normal, with electron detection in constant analyser energy mode (CAE=20 eV). The C(1s) envelopes were fitted to Gaussian components with equal full-width-at-half-maximum using a Marquardt computer algorithm. Instrumental sensitivity (multiplication) factors were taken as C(1s):O(1s:N(1s):Cl(2p) equals 1.00:0.36:0.60:0.34 respectively.

A FTIR spectrometer (Perkin-Elmer Spectrum One) equipped with a liquid nitrogen cooled MCT detector and p-polarization variable angle accessory (Specac Ltd) was used for reflection-absorption (RAIRS) measurements. The incident infrared beam was set at an angle of 66° from the substrate normal, and all spectra were acquired at 4 cm⁻¹ resolution over 256 scans.

Sessile drop contact angle measurements were carried out using a video capture apparatus (A.S.T. Products VCA2500XE) with 2 μl high purity water drops and averaged over 5 readings.

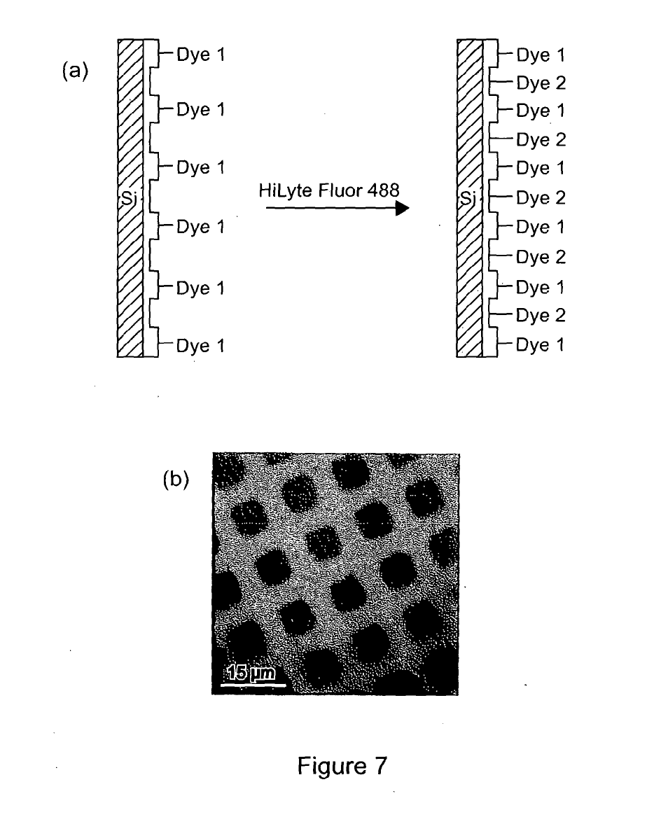

Fluorescence mapping for the monofunctional cresyl violet dye patterns was performed using a Raman microscope (Labram, Jobin Yvon Ltd). The Ne˜He laser (632.8 nm line, 20 mW power) beam was scanned across the substrate surface using 1.0 μm steps to give a fluorescence map. The backscattering configuration of the instrument allowed the simultaneous acquisition of both Raman and fluorescence signal. In the case of the bifunctional dye patterns, fluorescence microscopy was performed using an Olympus IX-70 microscope driven by the SoftWorx package system (DeltaVision RT, Applied Precision). Image data was collected using excitation wavelengths at 488 nm and 633 nm corresponding to the absorption maxima of the dye molecules, Hilyte Fluor 488 amine and cresyl violet perchlorate respectively as shown in FIG. 7.

Negative Image Patterning

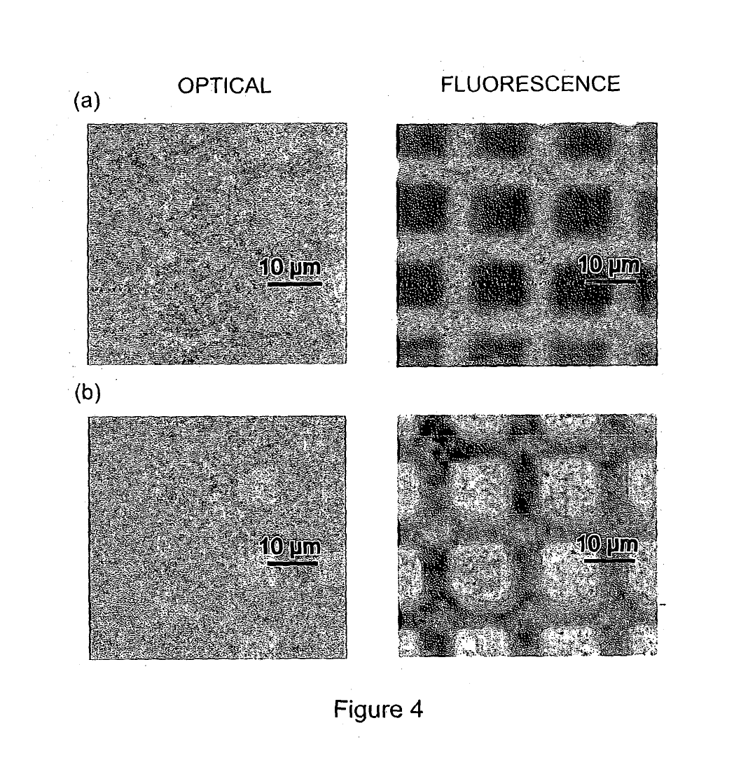

Exposure of the cresyl violet perchlorate functionalised maleic anhydride plasma polymer surface to UV light through a photomask in air gave rise to localized destruction (oxidation) of immobilised dye species which were removed by subsequent rinsing in N,N-dimethylformamide, FIG. 2 and FIG. 4. Patterned 20 μm×20 μm squares were clearly distinguishable by optical microscopy, where the bright areas correspond to UV irradiation and the dark regions are unexposed (non-degraded). The patterned surface was also mapped using fluorescence microscopy, since the cresyl violet perchlorate dye fluoresces at an excitation maximum of 637 nm to produce an emission maximum at 654 nm. Fluorescence imaging of the patterned surface confirmed cresyl violet perchlorate dye attachment onto the maleic anhydride pulsed plasma layer only in the UV unexposed regions. The optical and fluorescence images were found to be complementary to each other as shown in FIG. 4. Similar features were observed if the maleic anhydride plasma polymer surface was UV-patterned prior to immersion in cresyl violet perchlorate solution.

Rewriting and Positive Image Patterning

Reaction of 4-ethylaniline vapour with the deposited maleic anhydride pulsed plasma polymer surface gave rise to ring opening of the cyclic anhydride centres to yield amide linkages (amide I at 1658 cm⁻¹ (G), amide II at 1563 cm⁻¹ (H) and CN—H monosubstituted amide (1490-1400 cm⁻¹ (I)), and carboxylic acid groups (1721 cm⁻¹ (F)). Once again, reaction appeared to be restricted to just the near-surface region (i.e. background maleic anhydride pulsed plasma polymer infrared features remain). Heating to 120° C. gave rise to cyclic imide formation, as seen by attenuation of the characteristic amide and acid absorption bands in conjunction with the emergence of two imide stretching bands at 1777 cm⁻¹ (J) and 1711 cm⁻¹ (K).

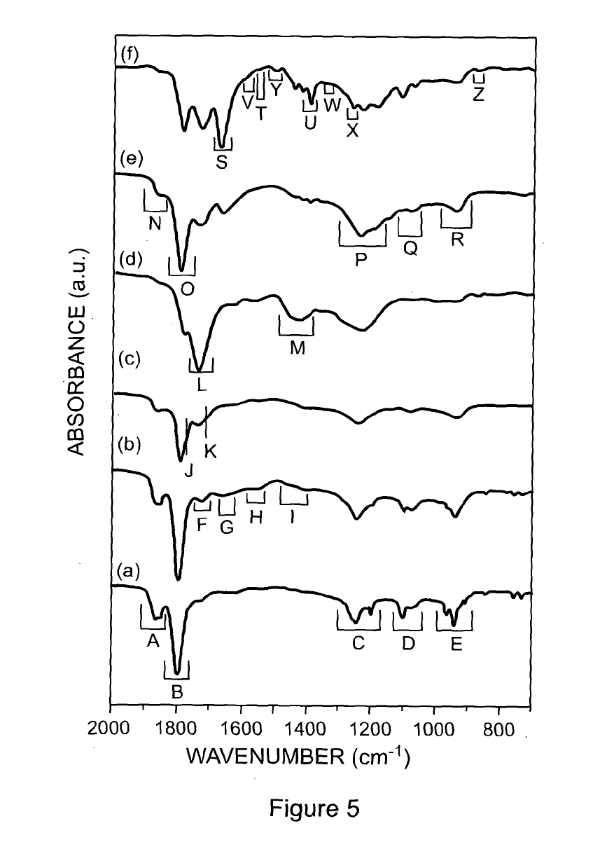

Infrared analysis following UV exposure and then rinsing in water of these imide functionalized surfaces indicated a drop in intensity of the asymmetric and symmetric maleic anhydride group C═O stretching bands (1860 cm⁻¹ (A) and 1796 cm⁻¹ (B)) and the appearance of a strong new band at 1730 cm⁻¹ (L) attributable to overlap between C═O stretching features of non-hydrogen bonded and hydrogen bonded carboxylic acid centres. There was also a broad absorbance centred at 1411 cm⁻¹ (M) belonging to COO³¹ symmetric stretching vibrations. Further reaction with trifluoroacetic anhydride resulted in the feature centred at 1730 cm⁻¹ (L) losing intensity to be replaced by two characteristic anhydride group absorption bands at 1859 cm⁻¹ (N) and 1790 cm⁻¹ (O). Accompanying cyclic anhydride group stretching (1230 cm⁻¹, 1180 cm⁻¹ (P)), C—O—C stretching vibrations (1107 cm⁻¹, 1074 cm⁻¹ (Q)), and cyclic unconjugated anhydride group stretching (broad band centered at 937 cm⁻¹ (R)) absorbances were also observed. These regenerated anhydride surfaces were then immersed into a solution of cresyl violet perchlorate dissolved in anhydrous 1-methyl-2-pyrrolidinone to give localised dye attachment via amide bonds (amide I at 1666 cm⁻¹ (S)) and electrostatic acid-base interactions (COO⁻ stretching at 1405 cm⁻¹ (U) and NH₂⁺ deformations at 1592 cm⁻¹ (V). In addition, the strong fingerprint spectral features associated with the cresyl violet perchlorate dye were evident: C—N stretching and C—N—H bending (1335 cm⁻¹ (W)), C—H bending and NH₂ rocking (1256 cm⁻¹ (X)), NH₂ in-phase bending and NH₂ rocking (1514 cm⁻¹ and 1485 cm⁻¹ (Y)), and C—H wagging and twisting band (872 cm⁻¹ (Z)), FIG. 5. Verification of the rewriting step was undertaken by placing a 0.1 μl droplet of cresyl violet dye solution onto a maleic anhydride pulsed plasma polymer film surface, and then the substrate was rinsed with N,N dimethylformamide, followed by drying under a stream of nitrogen. Fluorescence microscopy confirmed the attachment of cresyl violet perchlorate dye (excitation wavelength 637 nm) onto the substrate.

This fluorescence signal completely disappeared after UV exposure and rinsing in water. Subsequent dipping of the substrate into a solution of trifluoroacetic anhydride and triethylamine dissolved in anhydrous N,N dimethylformamide gave rise to the reformation of anhydride groups. Repetition of placing a 0.1 μl droplet of cresyl violet dye solution onto the regenerated area and rinsing with N,N dimethylformamide, once again resulted in fluorescence, thus confirming dye attachment onto the substrate. This rewritable behavior was repeated over 10 times, and ultimately depends upon the thickness of the pulsed plasma polymer film. A range of other dyes behaved in a similar fashion towards UV irradiation and surface regeneration, including 1-pyrenemethyl amine hydrochloride (excitation wavelength 325 nm) and 7-amino-4-methylcoumarin (excitation wavelength 353 nm).

Contact angle measurements taken at each stage of reaction for FIG. 3 were found to be consistent with the aforementioned description. A negligible change in water contact angle (46° to 50°) occurred upon reaction of 4-ethylaniline with the maleic anhydride plasma polymer surface. Whilst imidization produced a more marked increase in contact angle (57° due to the elimination of surface carboxylic acid groups. Similarly, an improvement in hydrophobicity was noted following the regeneration of anhydride groups at the UV-hydrolysed surface (from 15° to) 45°. The final cresyl violet perchlorate dye attachment step led to a lowering in contact angle value to 38° as a consequence of anhydride ring opening.

Patterned UV photo-rewriting of these surfaces gave rise to the selective attachment of cresyl violet perchlorate dye molecules exclusively in the regenerated anhydride group regions (i.e. positive imaging), FIGS. 4 and 5. The multifunctional feature of this approach was illustrated by creation of a bifunctional pattern. Fluorescence imaging confirmed the generation of a bifunctional surface with cresyl violet dye (bars) and Hilyte Fluor 488 amine dye (squares) attached onto the maleic anhydride pulsed plasma layer, FIG. 7.

As is shown the invention provides a simple and reproducible way of producing pattered surfaces. Previous reports of single write patterning of dyes onto solid surfaces have included the attachment of dansyl dyes onto hyperbranched poly(acrylic acid) organic thin films using a five step approach, a four step method utilising microcontact printing of COOH-terminated self-assembled monolayers (SAMs), electrochemical oxidation of SAMs and a multi-stage vapour deposition process.

The current methodology offers a number of distinct advantages. These include the fact that only 2 steps are required (pulsed plasmachemical deposition and molecular inking), the surface density of tethered dye molecules can be tailored by varying the pulsed plasma duty cycle parameters, and a variety of substrates can be utilized (unlike for instance self-assembled monolayer systems). Furthermore, it is evident that UV lithography can be employed to prepare multifunctional rewritable arrays. The surface anhydride groups should also be amenable to a range of other chemistries including hydrolysis, acylation, acetylation, and esterification.

It is to be understood that the above embodiments have been provided only by way of exemplification of this invention, such as those detailed below, and that further modifications and improvements thereto, as would be apparent to persons skilled in the relevant art, are deemed to fall within the broad scope and ambit of the present invention described. Furthermore where individual embodiments are discussed, the invention is intended to cover combinations of those embodiments as well.

1. A method of producing a patterned functionalized surface, the method involving:
(i) contacting a surface with a polymer having reactive groups so the groups are deposited on the surface to produce a functionalized polymer layer on said surface; and
(ii) contacting the functionalized polymer layer with a functional molecule that reacts with the functionalized polymer layer to produce a patterned surface having one or more areas of reactive surface functionality.

2. A method according to claim 1 wherein the substrate material is selected from one or more of woven or non-woven fibres, natural fibres, synthetic fibres, metal, glass, ceramics, semiconductors, cellulosic materials, paper, wood, or polymers such as polytetrafluoroethylene, polyethylene or polystyrene.

3. A method according to claim 1, wherein the surface is a silicon layer.

4. A method according to claim 1, wherein the polymer is formed by one or more of the following: plasma deposition, plasma polymerization, thermal chemical vapour deposition, initiated chemical vapour deposition (iCVD), photodeposition, ion-assisted deposition, electron beam polymerization, gamma-ray polymerization, target sputtering, graft polymerization, or solution phase polymerization.

5. A method according to claim 4, wherein the polymer is formed by plasma deposition.

6. A method according to claim 5, wherein the process is a pulsed plasma deposition.

7. A method according to claim 1, wherein the reactive group is an anhydride, in particular a maleic anhydride.

8. A method according to claim 1, wherein the functional molecule is a dye nucleophile containing ink, in particular cresyl violet perchlorate.

9. A method according claim 1, wherein the functionalized polymer layer is polymerized prior to contacting with the dye as in step (ii).

10. A method according to claim 1, wherein the patterned surface is produced by irradiating the functionalized polymer layer in discrete areas prior to contacting said layer with one or more dyes.

11. A method according to claim 1, wherein the patterned surface is produced by irradiating the functionalized polymer layer after contacting said layer with the dye.

12. A method according to claim 10, wherein the radiation is undertaken using a beam of plasma, photons, electrons, ions, radicals, atomic species, or molecular species or is UV irradiation.

13. A method according to claim 10, wherein a pattern on the patterned surface is produced by irradiating though a mask.

14. A method according to claim 1, wherein the pattered functionalized surface is erasable to allow rewriting of the patterned functionalized surface.

15. A method according to claim 1, wherein the surface density of the groups or dye on the surface is controlled by varying the plasma duty cycle.

16. A method of producing a functionalized polymer layer to be later patterned according to claim 1, the method involving contacting a surface with a plasma polymer having reactive groups so the groups are deposited on the surface to produce a functionalized polymer layer on said surface.

17. A method according to claim 16, where the surface is silicon and the plasma polymer forms a nano-layer on the silicon.

18. A functionalized patterned surface produced by a method according to claim 1.

19. A functionalized polymer layer produced by a method according to claim 16.

20. A functionalized patterned surface or functionalized polymer layer according to claim 18 used in molecular lattice devices, organic photoreceptors, clinical immunoassays, specific cell marking (dye-protein interactions), and genetics (dye-DNA interactions).
